(19) United States
(12) Patent Application Publication
(10) Pub. No.: US 2005/0109991 A1
(43) Pub. Date: May 26, 2005

(54) Mixture of metal and/or alloy particles and a liquid medium, and process for the preparation thereof

(75) Inventor: Wolfgang Glaeser, Goslar (DE)

Correspondence Address: JACOBSON HOLMAN PLLC, 400 SEVENTH STREET N.W., SUITE 600, WASHINGTON, DC, 20004, US

(73) Assignee: Grillo-Werke AG

(21) Appl. No.: 10/996,049

(22) Filed: Nov. 24, 2004

Related U.S. Application Data
(63) Continuation of application No. 09/926,683, filed on Dec. 3, 2001.

(30) Foreign Application Priority Data
Jun. 1, 1999 (DE) 199 25 048.8

(51) Int. Cl. H01M 4/36; H01M 4/48

(52) U.S. Cl. 252/500; 252/512; 429/105

(57) ABSTRACT

The mixture of metal and/or alloy particles and a liquid electrolytic medium has the property that the volume of the medium approximately corresponds to the spaces between the particles in a dry packing (for example, according to ASTM-B 212). This ensures a direct metallic contact between the particles.

The present invention relates to a mixture of metal and/or alloy particles and a liquid electrolytic medium, and a process for the preparation thereof. Such mixtures are known and are used for different purposes, those mixtures being particularly important in which the metal and/or alloy particles can dissolve in the liquid electrolytic medium and thereby release electric current. Thus, in particular, these are mixtures of metal or alloy particles in which the particles can dissolve in an acid or lye. Such chemical reactions are extensively used for the production of electric current, for example, in batteries and accumulators, i.e., rechargeable batteries.

A very frequently employed mixture consists of zinc particles or particles of a zinc alloy and solutions of alkali as the liquid electrolytic medium. These mixtures are employed, for example, together with mixtures of manganese dioxide with components of a liquid electrolytic medium, the two mixtures mostly being separated by a separator. The particles of zinc or zinc alloys are prepared from liquid zinc or liquid zinc alloys according to various known methods, for example, by atomization or granulation on a rotating granulating dish. Depending on the process conditions, the grain sizes, the grain size distribution and the outer shapes of the particles can be adjusted, sieve fractions often being separated from the oversize and undersize.

From WO 99/07030, it is known to selectively admix more or less superfine grains with the per se known particles of zinc or zinc alloys, because this is supposed to reduce the sensitivity towards mechanical shocks. It is believed that these properties can be attributed to the fact that a more favorable rate of volume to surface of the particles is provided and the properties of the batteries are thereby improved, and/or the superfine grain provides for better contacts between the particles.

For stabilizing the mixtures of particulate zinc and an electric electrolyte, various methods have been known. Thus, for example, DE-PS-818 519 describes the addition of paper fibers and a gelling agent for dry cell electrodes. DE-AS-25 10 934 describes a water-insoluble cross-linked polyacrylamide as a binder, indicating that the previously employed binders, such as sodium carboxymethylcellulose, did not meet with the desired success.

It has been the object of the invention to provide mixtures of metal and/or alloy particles and a liquid electrolytic medium which, for example, when incorporated in batteries and accumulators, exhibit optimum properties in terms of performance, durability, resistance to heavy discharges and mechanical shocks while the release of gases is avoided.

This object has now been achieved by the volume of the liquid electrolytic medium approximately corresponding to the spaces between the particles in a dry packing (for example, according to ASTM-B 212). This is equivalent to the demand that the volume of the mixture be approximately equal to or little larger than the volume of a dry packing of the metal and/or alloy particles. In these mixtures, it is practically ensured that there is a direct contact between almost all particles while there is still enough liquid electrolytic medium to dissolve the metal and/or alloy particles to produce current. In contrast, according to the prior art, the mixture contains from about 50 to 100% more liquid electrolyte than would fit into the spaces between the particles in a dry packing. Accordingly, the volume of such mixtures is significantly higher than would correspond to the volume of the particles in a dry packing.

A possible drawback of the mixtures according to the invention is the fact that they cannot easily be dosed in the usual way due to their being neither flowable nor free-flowing, but having a relatively solid consistency. Therefore, to be able to prepare these mixtures and fill them in a dosed manner, for example, into batteries, it is possible to first prepare a mixture with excess amounts of the electrolytic medium and to take care that this excess can flow from the mixture later after the dosing or is sucked off. When batteries based on particles of zinc or zinc alloys and manganese dioxide are prepared, this can be achieved relatively easily by partly or completely dispensing with moistening the separator, for example, made of paper or non-woven materials, after the manganese dioxide has been introduced and the separator inserted, and the amount of liquid medium to be employed is first used for rendering the mixture of metal and/or alloy particles and the liquid electrolytic medium more easily dosable.

Then, after this dosable mixture has been introduced, the excess amount of the electrolytic medium is sucked off through the separator and also supplied to the manganese dioxide. Thus, the finished battery contains amounts of electrolytic medium which are altogether comparable with those used for batteries prepared by previous methods. In contrast, the mixture of metal and/or alloy particles no longer contains the usual volume excess of liquid electrolytic medium, which has previously been chosen for the mixture to be readily dosable. However, the volume of the liquid medium did not fit into the free pore volume of the particles in a dry packing.

To prevent the later settling of the metal and/or alloy particles in the electrolytic media, a gelling agent has previously been added to these mixtures. However, both the gelling agent and the excess amount of electrolytic medium can affect the properties of the finished battery and even deteriorate certain properties. For example, not all of the particles are in immediate contact with other particles, so that there is no electronic conductivity between them. Thus, the internal resistance of the battery increases. The addition of gelling agent can reduce the electric conductivity of the electrolytic medium. Further, all previously prepared batteries have been more or less sensitive towards heavy mechanical impacts and shocks.

The use of the mixtures according to the invention, in which the volume of the medium approximately corresponds to the spaces between the particles in a dry packing, provides a practically direct metallic contact between almost all particles.

This reduces the internal resistance of the battery and, above all, also reduces the sensitivity towards shocks.

Since the aggregation of these particles is relatively stable, the use of gelling agent can even be dispensed with more or less. At any rate, the amount of gelling agent added can be significantly reduced. However, the previously usual amounts may also be added, if desired.

A dry packing is a still relatively loose aggregation. By intensively vibrating and shaking, such dry packings can altogether be further condensed. However, since a sufficient amount of liquid electrolytic medium is also necessary in batteries, the maximum possible condensation of the metal and/or alloy particles is avoided. However, the previously employed significant volume excess of liquid electrolytic medium is also avoided. According to the invention, the mixtures are first rendered dosable with excess amounts of the electrolytic medium, then dosed and thereafter freed from the excess amounts of electrolytic medium. In practice, this is effected by suction, wherein this superfluous amount is taken up by the separator and cathode, for example.

The bulk density of a dry packing, for example, according to ASTM-B 212, is highly dependent on the grain size, the grain size distribution and the outer shape of the particles. In order to achieve, on the one hand, the advantage of the relatively stable structure with metallic contact between the particles, and on the other hand, to be able to accommodate sufficient amounts of liquid electrolytic medium in the mixture, it is recommendable, when zinc or zinc alloys are used, to employ a material which has a dry bulk density of lower than 2.8 g/ml. This is possible, for example, when a material is used which contains many elongated or elongated-flat particles due to its production method, because this results in a lower bulk density. This means that there is a relatively large pore volume between the particles. When such materials are used, it is altogether possible then to prepare a comparable weight distribution between the metal particles and the liquid electrolytic medium in the finished battery, as in the previously prepared batteries. This distribution of weights has proven useful in principle, and therefore the battery manufacturers would not much like to substantially change it. According to the invention, the manner of dosing the mixtures of metal and/or alloy particles and the liquid electrolytic medium needs not to be changed either. However, the moistening of the separator with impregnation electrolyte may be changed. This step may either be completely omitted, or performed with a clearly lower amount of impregnation electrolyte, because the mixture of metal and/or alloy particles and the liquid electrolytic medium as used according to the invention is capable of releasing the excess electrolytic medium to the separator and cathode. In addition, the preparation of the batteries in the various standardized sizes can still be effected in an unchanged manner. For examples the mercury-free zinc alloys usual today, which are little gassing and are environment-friendly, can be employed. However, the mixtures of metal and/or alloy particles and a liquid electrolytic medium according to the invention may also be employed in other types of batteries and accumulators to bring about novel and advantageous properties of the batteries and accumulators.

1-7. (canceled)

8. A mixture comprising zinc and/or zinc alloy particles in a liquid electrolytic medium characterized in that
a) the volume of the medium substantially corresponds to the spaces between the particles in a dry packing,
b) the particles include elongated particles or elongated-flat particles,
c) the particles have a bulk density of less than 2.8 g/ml,
d) the volume of the mixture is substantially equal to the volume of the dry packing of the particles, and
e) the mixture exhibits direct contact between substantially all of the particles.

9. The mixture according to claim 8, characterized in that the electrolytic medium contains a gelling agent.

10. A battery or accumulator containing the mixture according to claim 8.

11. A battery or accumulator containing the mixture according to claim 9.

12. A process for preparing a mixture comprising zinc and/or zinc alloy particles in a liquid electrolytic medium characterized in that
a) the volume of the medium substantially corresponds to the spaces between the particles in a dry packing,
b) the particles include elongated particles or elongated-flat particles,
c) the particles have a bulk density of less than 2.8 g/ml,
d) the volume of the mixture is substantially equal to the volume of the dry packing of the particles, and
e) the mixture exhibits direct contact between substantially all of the particles,
the process characterized in that a dosable mixture with excess amounts of the electrolytic medium is prepared first, which excess is sucked off from the mixture after the dosing.

13. A process for preparing a mixture comprising zinc and/or zinc alloy particles in a liquid electrolytic medium characterized in that
a) the volume of the medium substantially corresponds to the spaces between the particles in a dry packing,
b) the particles include elongated particles or elongated-flat particles,
c) the particles have a bulk density of less than 2.8 g/ml,
d) the volume of the mixture is substantially equal to the volume of the dry packing of the particles, and
e) the mixture exhibits direct contact between substantially all of the particles,
the process characterized in that a dosable mixture with excess amounts of the electrolytic medium is prepared first, which excess is taken up by a separator and cathode.

14. A mixture comprising zinc and/or zinc alloy particles in an electrolytic medium characterized in that
a) the volume of the medium substantially corresponds to the spaces between the particles in a dry packing,
b) the particles include elongated particles or elongated-flat particles,
c) the particles have a bulk density of less than 2.8 g/ml,
d) the volume of the mixture is substantially equal to the volume of the dry packing of the particles, and
e) the mixture has a solid consistency and exhibits direct contact between substantially all of the particles.

15. The mixture according to claim 14, characterized in that the electrolytic medium contains a gelling agent.

16. A battery or accumulator containing the mixture according to claim 14.

17. A battery or accumulator containing the mixture according to claim 15.

18. A process for preparing a mixture of zinc and/or zinc alloy particles in a liquid electrolytic medium, in which a material containing many elongated or elongated-flat particles is used, characterized in that the particles have a bulk density lower than 2.8 g/ml, the volume of the mixture is equal to the volume of a dry packing of the zinc and/or zinc alloy particles, and the mixture exhibits direct contact between substantially all of the particles, characterized and that a dosable mixture with excess amounts of the electrolyte medium is prepared first, which excess is sucked off from the mixture after the dosing.

19. A process for preparing a mixture of zinc and/or zinc alloy particles in a liquid electrolytic medium, in which a material containing many elongated or elongated-flat particles is used, characterized in that the particles have a bulk density lower than 2.8 g/ml, the volume of the mixture is equal to the volume of a dry packing of the zinc and/or zinc alloy particles, and the mixture exhibits direct contact between substantially all of the particles, characterized and that a dosable mixture with excess amounts of the electrolyte medium is prepared first, which excess is taken up by a separator and cathode.
